(19) United States
(12) Patent Application Publication
(10) Pub. No.: US 2008/0296918 A1
(43) Pub. Date: Dec. 4, 2008

(54) Safety Device for a Shell Structure of a Motor Vehicle

(76) Inventors: Christoph Mueller, Sindelfingen (DE); Jochen Ruf, Pforzheim (DE); Josef Sailer, Haigerloch (DE); Alfred Schnabel, Althengstett (DE)

Correspondence Address: CROWELL & MORING LLP;INTELLECTUAL PROPERTY GROUP, P.O. BOX 14300, WASHINGTON, DC, 20044-4300, US

(21) Appl. No.: 10/558,250

(22) PCT Filed: Apr. 23, 2004
(86) PCT No.: PCT/EP2004/004299

§ 371 Date: Aug. 22, 2008

(30) Foreign Application Priority Data
May 28, 2003 (DE) 103 24 270.8

(51) Int. Cl. B60R 19/18

(52) U.S. Cl. 293/110

(57) ABSTRACT

A motor vehicle shell structure has longitudinal side members which extend from a wheel arch along the outer shell structure in the direction of travel and a bumper arrangement arranged in front of the wheel arch in the direction of travel and having a cross member and an energy absorbing element. A safety device for a motor vehicle shell structure which increases the safety of vehicle occupants is achieved by arranging the energy absorbing element is arranged on the cross member at the height of the wheel arch so that it extends between the cross member and the wheel arch.

### BACKGROUND AND SUMMARY OF THE INVENTION

This invention relates to a safety device for a motor vehicle shell structure.

A safety device for a motor vehicle shell structure is known, for example, from German document DE 198 12 701 A1. This known safety device for a motor vehicle shell structure has longitudinal members running in the longitudinal direction of the vehicle and also a cross member belonging to a bumper arrangement. A deformation element is arranged between the cross member and the longitudinal members in order to absorb collision energy in the event of a vehicle collision.

Furthermore, a motor vehicle shell structure is known from European document EP 0 067 407 A1 in which existing hollow spaces are used to arrange components, such as for example a washer water container, from an engine compartment. Such a hollow space is formed in the vertical direction by an engine compartment bulkhead and an outer metal sheet of a fender running essentially parallel to the bulkhead. In the horizontal direction, the hollow space is delimited by a splash guard and also an extension of the bumper arrangement. A container for washer water is arranged in the hollow space.

The object of the present invention is to produce a safety device for a motor vehicle shell structure which increases the safety of vehicle occupants.

This object is achieved according to the invention by means of a safety device for a motor vehicle shell structure as claimed.

The invention is distinguished by an energy absorbing element which is arranged on the cross member of the bumper arrangement, specifically in such a way that it extends between the cross member and a wheel arch. It is conceivable that the energy absorbing element at least partly delimits the wheel arch. The arrangement according to the invention of the energy absorbing element opens up an additional force path into the motor vehicle shell structure, which path runs from the cross member via the energy absorbing element into a wheel and from the wheel onwards into a longitudinal side member which extends behind the wheel. The opening of an additional force path has a wide range of advantages. In the event of a crash, the energy absorbing element presses against the wheel at an early stage. As a result, the wheel is pressed against the longitudinal side member earlier. This prevents the wheel from rotating inwards in the event of a collision and thus contributes to greater energy absorption.

In the event of the vehicle colliding with an obstruction, the vehicle is abruptly decelerated, whereby energy of the moving vehicle is abruptly dissipated. Given that the vehicle is not rigid, the vehicle deceleration and therefore the energy dissipation do not occur instantaneously but rather over a certain period of time. If the vehicle deceleration is plotted against time, a so-called deceleration or acceleration characteristic curve (negative acceleration of the vehicle) is obtained. This deceleration characteristic curve is dependent on the construction of the vehicle and, when considering the front region of a vehicle, on the powertrain that is arranged therein, so that every vehicle has a specific deceleration characteristic curve. It is particularly favourable, in terms of the forces to which the vehicle occupants are subjected, if the deceleration begins as early as possible and is then continued at a constant level. In this way, deceleration peaks, that is to say large decelerations within a very short time, which can result in the vehicle occupants being subjected to intense forces, are avoided.

Deceleration values are lower if hollow spaces, which provide no resistance against the collision, are provided in the vehicle. This is based on the fact that energy cannot be dissipated by such hollow spaces. If, for example, such hollow spaces are arranged in front of an engine in a front region of a vehicle, the main deceleration of the vehicle after a collision only begins when the hollow spaces in front of the engine have been compressed and a block formation of cross member, engine and shell structure occurs. This results in most of the energy being dissipated only at the end, via a shorter route and in a very short time, which leads to those deceleration peaks and thus to the vehicle occupants being subjected to intense forces. As the hollow spaces are compressed, time thus elapses which is not being used for energy absorption.

Force can be dissipated, and energy converted, at an earlier stage by the arrangement according to the invention of the energy absorbing element, which fills up a hollow space, and thus by the early inclusion of the wheel and of the longitudinal side member in the force path. As a result, the deceleration characteristic curve rises earlier, whereby force peaks during the dissipation of energy can be avoided. As a result, an intrusion of the dashboard is effectively prevented. In addition, the production of an additional so-called outer force path means that the energy in the vehicle front end can be dissipated more evenly, since it is not only the route via the centrc center, that is to say via the inner longitudinal members and the drivetrain, that is chosen.

It is conceivable to design the energy absorbing element to be at least partly hollow. This has the advantage that it can serve as a container for receiving, for example, fluids.

It is also conceivable to design the energy absorbing element in such a way that it absorbs energy only once a predefined force has been exceeded. The absorption of energy generally involves deformation of the corresponding component. The configuration of the energy absorbing element which has just been described makes it possible to transmit energy via the energy absorbing element until the predefined force is reached, which energy can be used to push the wheel, which is arranged behind the energy absorbing element, against the longitudinal side member. Deformation with accompanying energy absorption can only take place once the wheel has reached the longitudinal member.

It is also conceivable to design the energy absorbing element as a container for operating materials such as washer water. This has the advantage that the energy absorbing element performs two functions simultaneously, energy absorption and receiving operating media, as a result of which considerable installation space can be saved in the vehicle front end. The integration of several functions into one component also has advantages in terms of production costs.

The container for operating media can have an additional structure which serves for energy absorption. This additional structure can be arranged either in the container or outside the container. An arrangement in the container has advantages in terms of the installation space.

The invention is described in the following text by means of the exemplary embodiment illustrated in the drawings.

### BRIEF DESCRIPTION OF THE DRAWINGS

FIG. 1 shows a three-dimensional view of a front end of a motor vehicle shell structure from the side,

FIG. 2 shows a half of the motor vehicle shell structure according to FIG. 1 from below, and

FIG. 3 shows a three-dimensional view of a container according to the invention.

### DETAILED DESCRIPTION OF THE INVENTION

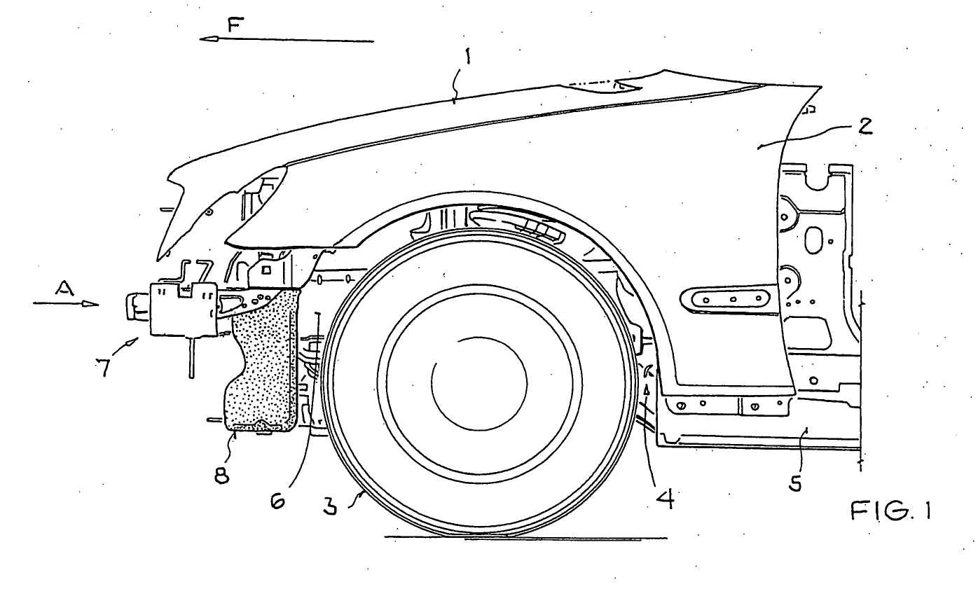

The left side of a front end of a motor vehicle shell structure is illustrated three-dimensionally in FIG. 1. In addition to the shell structure, parts of the outer covering—a front hood 1 and a fender 2—are illustrated. A front wheel 3 is also to be seen, which is arranged in a wheel arch 4.

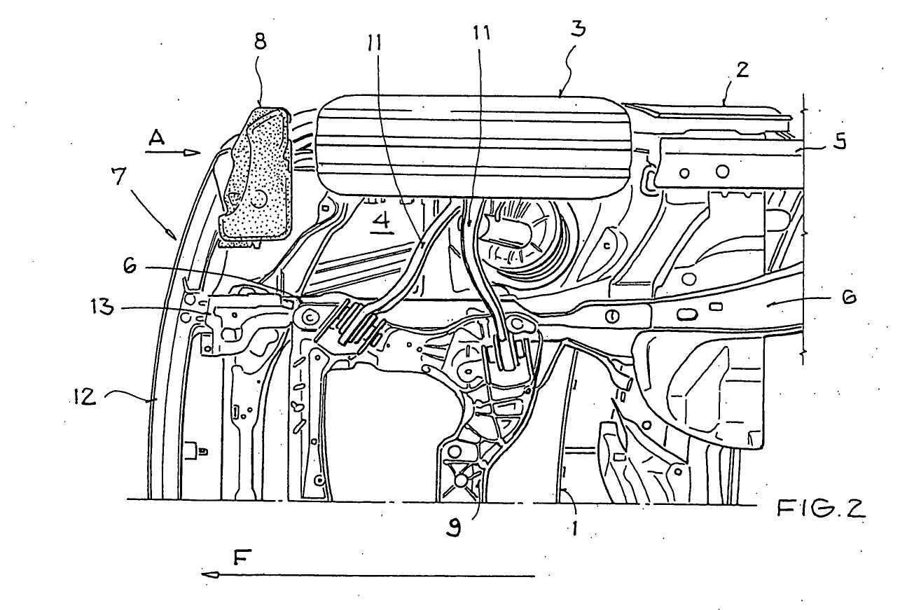

A longitudinal side member 5 follows on behind the wheel arch 4 as seen in the direction of travel (arrow F), which longitudinal side member extends from the wheel arch 4 along the outer shell structure in the longitudinal direction of the vehicle. A longitudinal central member 6, which runs behind the wheel, is also to be seen above a wheel axle which is not illustrated. The longitudinal central member 6, beginning at the front end of the vehicle, likewise extends in the longitudinal direction of the vehicle. A bumper arrangement 7 is provided at the forward-facing end of the longitudinal central member 6, which bumper arrangement will be described in even more detail with reference to FIG. 2.

A container 8 is arranged on the bumper arrangement 7. The container 8 is positioned in such a way that it extends between the bumper arrangement 7 and the front wheel 3. It is arranged so as to be at a distance from the front wheel 3, so that the movement which the front wheel carries out when steering is not impaired.

A half of the front end according to FIG. 1 is illustrated from below in FIG. 2. The front wheel 3 arranged in the wheel arch 4 is also to be seen here. The longitudinal side member 5 follows on behind the wheel arch 4. The longitudinal central member 6 similarly runs, adjoining the wheel arch 4, in the longitudinal direction, an integral member 9 being arranged on the longitudinal central member, which integral member supports a wheel suspension 11.

The bumper arrangement 7 is arranged at the front-facing end of the longitudinal member 6 as seen in the direction of travel (arrow F). This has a cross member 12 and also crash boxes 13 which are not illustrated in more detail, and via which the cross member is connected to the longitudinal central member.

The container 8 is fastened via conventional fastening means to the cross member 12. It is also conceivable to fasten the container 8 to other suitable elements of the motor vehicle shell structure.

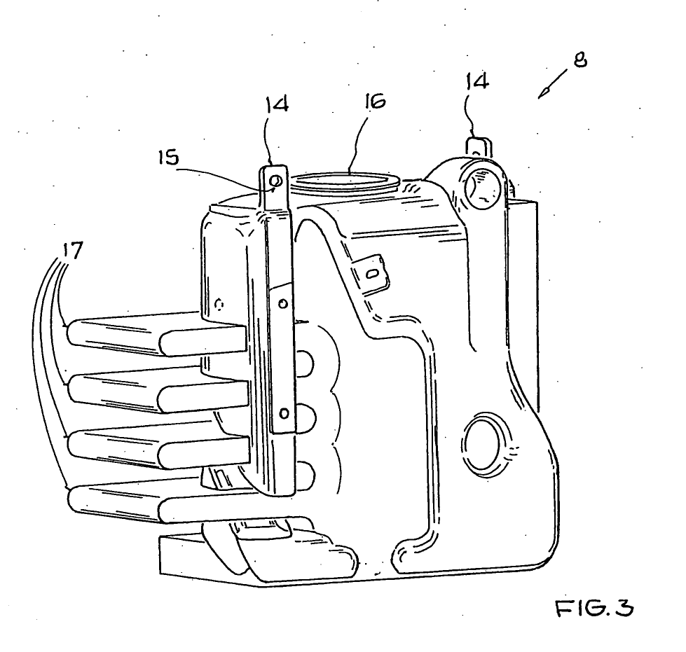

The container 8 is illustrated in FIG. 3. It has two protrusions 14 with holes 15 for receiving fastening elements which are not illustrated. An opening 16 is also provided by means of which the fluids to be received by the container 8 can be filled or removed. Ribs 17 are provided on the outer structure of the container, by means of which the deformation behavior of the container can be set. The container 8 behaves differently in the event of a collision, and can correspondingly absorb energy, depending on the length and width of the ribs 17 and/or the number of ribs 17 provided.

The following text describes how a collision force A which is introduced into the vehicle in the event of a vehicle collision is introduced into the motor vehicle shell structure. The collision force A is initially introduced, in the event of a frontal collision, into the cross member 12 of the bumper arrangement 7. A first force path then runs via the crash box 13 into the longitudinal central member 6. A further outer force path runs from the cross member 12 of the bumper arrangement 7 into the container 8. The container 8 is initially pushed backward by the bumper arrangement 7 until it touches the front wheel 3. The container 8 is designed to be so stiff that the next step is a displacement of the front wheel 3 onto the longitudinal side member. As soon as the second, outer force path is closed, the deformation of the container 8 occurs with corresponding energy absorption.

On the one hand, the additional lateral force path absorbs energy in a directed manner. Furthermore, the front wheel is pressed against the longitudinal side member early, as a result of which, firstly, the possibility of the front wheel rotating inwards is considerably reduced and, secondly, an additional force path is closed early, via which energy can be dissipated. The early dissipation of collision energy in particular has a positive effect on the deceleration characteristic curve, since an early dissipation of energy contributes to force peaks being reduced. This reduction has a positive effect on the forces to which the vehicle occupants are subjected. An early and additional dissipation of energy in the vehicle front end additionally has the advantage that dashboard intrusions are reduced.

1.-7. (canceled)

8. A safety device for a motor vehicle shell structure comprising:
longitudinal side members which extend from a wheel arch along outer shell structure in a direction of travel, and
a bumper arrangement arranged in front of the wheel arch in the direction of travel and having a cross member and an energy absorbing element,
wherein the energy absorbing element is arranged on the cross member of the bumper arrangement at a height of the wheel arch in such a way that the energy absorbing element extends between the cross member and the wheel arch.

9. The safety device as claimed in claim 8, wherein the energy absorbing element is formed to be at least partly hollow.

10. The safety device as claimed in claim 8, wherein the energy absorbing element is designed in such a way that it absorbs energy once a predefined force has been exceeded.

11. The safety device as claimed in claim 8, wherein the energy absorbing element is designed as a container for operating media.

12. The safety device as claimed in claim 11, wherein the container has an additional structure for energy absorption.

13. The safety device as claimed in claim 12, wherein the additional structure is integrated into the container.

14. The safety device as claimed in claim 12, wherein the additional structure is arranged outside the container.

15. The safety device as claimed in claim 9, wherein the energy absorbing element is designed in such a way that it absorbs energy once a predefined force has been exceeded.

16. The safety device as claimed in claim 9, wherein the energy absorbing element is designed as a container for operating media.

17. The safety device as claimed in claim 10, wherein the energy absorbing element is designed as a container for operating media.

18. The safety device as claimed in claim 15, wherein the energy absorbing element is designed as a container for operating media.

19. The safety device as claimed in claim 16, wherein the container has an additional structure for energy absorption.

20. The safety device as claimed in claim 17, wherein the container has an additional structure for energy absorption.

21. The safety device as claimed in claim 18, wherein the container has an additional structure for energy absorption.

22. The safety device as claimed in claim 19, wherein the additional structure is integrated into the container.

23. The safety device as claimed in claim 19, wherein the additional structure is arranged outside the container.

24. The safety device as claimed in claim 20, wherein the additional structure is integrated into the container.

25. The safety device as claimed in claim 20, wherein the additional structure is arranged outside the container.
